(19) United States
(12) Patent Application Publication
(10) Pub. No.: US 2017/0197599 A1
(43) Pub. Date: Jul. 13, 2017

(54) Decentralized air braking system with hydraulic or electrical actuation

(71) Applicant: Plamen Vladimirov Trifonov, SE BELLEVUE, WA (US)

(72) Inventor: Plamen Vladimirov Trifonov, SE BELLEVUE, WA (US)

(21) Appl. No.: 15/361,377

(22) Filed: Nov. 26, 2016

(51) Int. Cl. B60T 8/32; B60T 13/70; B60T 8/38; B60T 13/68; B60T 7/20; B60T 13/36

(52) U.S. Cl. CPC B60T 8/323; B60T 7/20; B60T 8/329; B60T 13/36; B60T 8/38; B60T 13/683; B60T 13/70

(57) ABSTRACT

The main innovation in the braking system presented for patent protection is that it avoids the use of a main brake valve, as well as the other cocks and valves used presently in the air brakes. The pressure in the brake chambers is regulated hydraulically or electrically at the input of each brake chamber individually. This minimizes, to the extent possible, the delay in the execution of the brake commands given by the driver. ABS control will also be individual for each wheel and will work several times faster and more accurately. Overall, the system will use much fewer air ducts, will be simpler and more secure. The diagnostics will be much faster and easier. For reequipping the vehicles with the presented braking system, no changes in their design are required.

### CROSS-REFERENCE TO RELATED APPLICATIONS

This application claims priority on the basis of U.S. Provisional Application Ser. No. 62/269,237, filed on Dec. 18, 2015.

This application is directed to similar subject as described in the patent application US reg. No 20060197376A1, published on Sep. 7, 2006 and titled “Hybrid Air Brake Actuation”, filed by Robert J. Herbst.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

(1) Field of the Invention

This invention relates to improving the performance of air brake systems of vehicles. Current air brake systems are operated from the main brake valve, which is connected to the brake pedal of the vehicle. When the driver renders pressure on the brake pedal, he feeds air pressure to the brake cylinders. They in turn drive the wheel brakes, which carry into effect the braking force. In brake systems build in such a way, the air travels a long way through a variety of additional relay valves. This creates a delay in the execution of the braking signal, which is inevitable due to the physical properties of air. The speed and precision of the execution of the braking commands directly depend on the type and number of air brake valves and the length of the ducts. ABS control is slow and not efficient.

(2) Description of the Related Art including information disclosed under 37 CFR 1.97 and 37 CFR 1.98.

Not Applicable

### BRIEF SUMMARY OF THE INVENTION

The present invention relates to a hybrid friction air braking systems in the wheel transport. In the case presented, the brake valves are actuated by the brake pedal through hydraulic or electric system. The object of the invention is to improve the speed and precision of response of the wheel brakes when commanded to actuate, or termination of already realized actuation. To simplify the brake system. To improve the ABS control. To facilitate diagnosis.

The proposed preferred version for realization is presented in the form of a hybrid hydraulic or electrical air brake system in which, instead of main air brake valve, separate brake valves for each individual wheel brake is used, also a separate valve, designed to actuate the brakes of attached trailers and semi-trailers equipped with standard air brake systems is included.

### BRIEF DESCRIPTION OF THE SEVERAL VIEWS OF THE DRAWING(S)

FIG. 1 shows a schematic view of a decentralized air brake system with hydraulic or electrical actuation.

FIG. 2 shows a longitudinal cross-section of the body of a wheel brake air valve with hydraulic actuation.

### DETAILED DESCRIPTION OF THE INVENTION.

The present invention is directed towards improvement in the performance and precision of air brake systems for wheeled vehicles.

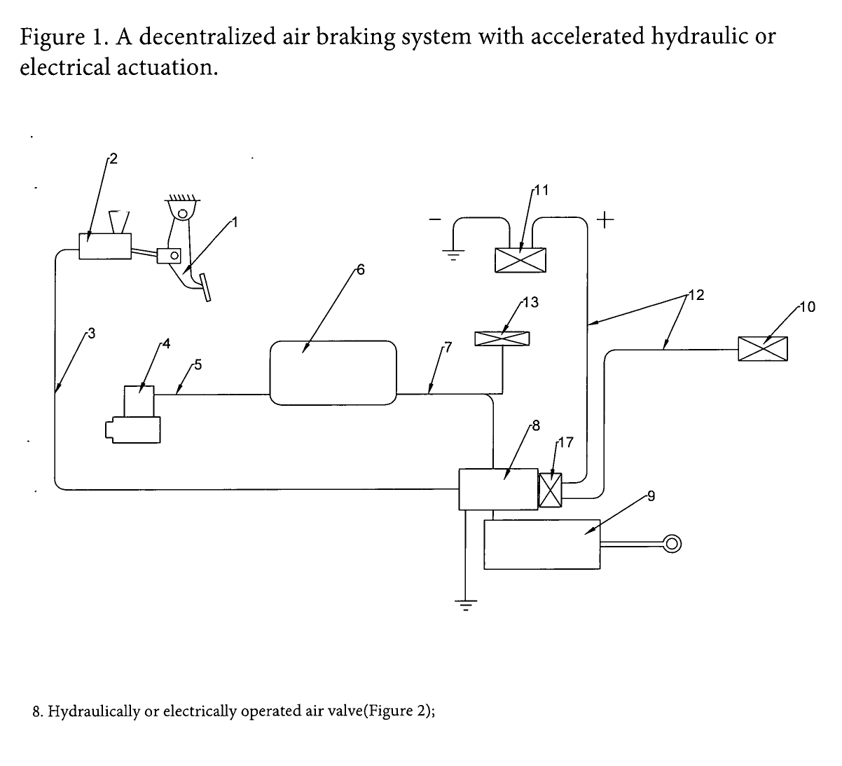

General view of one preferred version for realization is shown in FIG. 1. Here, actuation of the braking system is done hydraulically.

In this version, referring to FIG. 1 the combined hydraulic air brake valve 8 is connected via the hydraulic duct 3 with the hydraulic pump 2 actuated by the brake pedal 1. The air is compressed by the compressor 4 of the vehicle. Through duct 5 enters the air from reservoir 6. Through duct 7, compressed air is supplied to the wheel brake valve 8 and the valve 13. The valve 13 actuates the brakes of trailers, semi- trailers and wheel carriers. Source of electrical power 11 is the battery of the vehicle. Through the cables 12, power is supplied to the executive ABS module 17 which drives the distributor 15 on a signal of the ABS sensor 10 of the respective wheel. Brake cylinder 9 actuates the wheel brake.

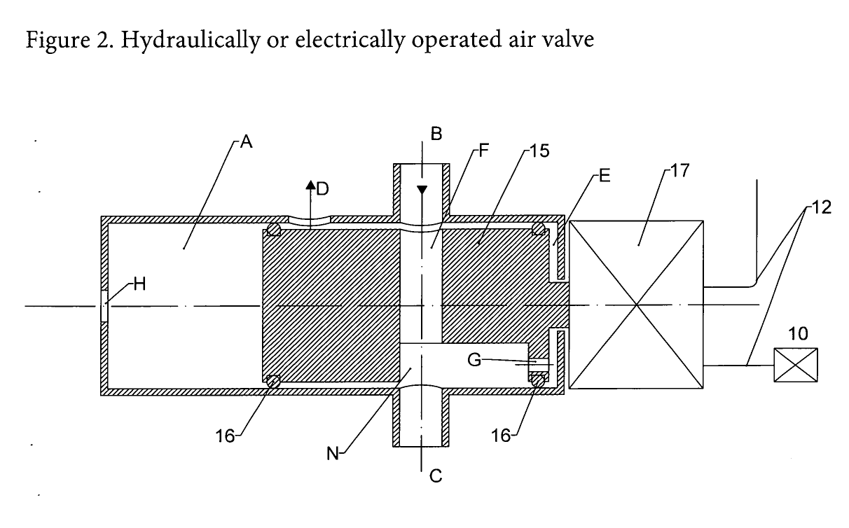

In FIG. 2 the longitudinal cross-section of the embodiment of combined hydraulic-air brake valve 8 from FIG. 1 is shown. In the body 14 is the axially movable distributor 15. The electrically actuated ABS unit 17 is an electric motor or an electromagnet. It is triggered by signals from the ABS sensor 10. The supply of electricity and signaling is carried out by the cables 12. The seals 16 provide sealing of the hydraulic chamber A, and the air chamber E. The opening B supplies from the reservoir 6 through duct 7 air with operating pressure.

Opening C is connected to the brake cylinder 9. The opening D is connected to the atmosphere. Channel F is the main working air channel in the distributor 15. Channel G connects camera E with the air volume N. In the volume N, the pressure is the same as in the brake cylinder 9. H is an opening through which the hydraulic fluid enters the chamber A. Chamber A is the operating hydraulic chamber. When the driver is exerting pressure on the brake pedal 1, the associated brake pump 2 through the hydraulic duct 3 feeds brake fluid under pressure through the opening H in the chamber A. The hydraulic pressure in chamber A drives the distributor 15 to a position where the duct F connects opening B with opening C. In this way the compressed air with operating pressure enters the wheel brake cylinder 9, which actuates the wheel brake. When channel F covers fully openings B and C, which are on one and the same axis, the maximum braking effect as speed and magnitude is achieved. Through the air channel G of the distributor 15, the air pressure in the chamber E is equalized with that of the volume N, and the pressure in the brake cylinder 9. This pressure drives the distributor 15 against the hydraulic pressure of the brake fluid in chamber A. In this way the driver feels on the brake pedal 1 the applied brake pressure in the brake cylinder. By reducing the pressure on the brake pedal 1, the pressure in the chamber E drives the distributor against the hydraulic pressure. When channel F covers opening D, through the volume N the brake chamber is connected to the atmosphere and braking is terminated. The ABS module 17, depending on the signals of the wheel sensor 10, drives the distributor 15 through the elongation that enters into module 17. This movement may be radial or axial, depending on the type and design of the valve 8.

In another version, a hydraulic system is replaced by an electrical one. In it, the brake pedal is connected to electrical command module from where through cable or wireless commands, wheel electric actuating module is controlled. This may be an electrical motor or an electromagnet. It moves the distributor 15 of the brake valve 8. Here the commands from the ABS sensor are executed directly by the wheel actuating electrical module.

In spite of the invention described in the presented preferred version for realization, to specialists in the field it is clear that there are many alternatives, modifications and variations. Accordingly, the present invention is intended to spread over all such alternatives, modifications and variations that fall within the scope of the requested claims. The upper description of the specific realization of the present invention is represented for the purposes of the illustrated description. It is not intended to be comprehensive or to impose limits to the just described form. The described example is chosen and described for the best explanation of the principles and scope of the present invention and its practical application. This will enable other specialists in the field to use the best of the invention in various realizations and modifications which are appropriate for a particular use.

1. Decentralised air brake system for wheeled vehicles with hydraulic or electric regulation of air pressure in the brake chambers, which includes:
a) Hydraulically or electrically controlled air brake valves that regulate air pressure individually in each wheel air chamber and are mounted on the camera itself or next to it, on the frame of the vehicle.
b) Electrically actuated ABS modules that are installed in each wheel brake valve and receive signals directly from the respective wheel ABS sensor.
c) Hydraulic or electrical system, triggering wheel air valves, with the commands given from the driver's seat.

2. Decentralized air brake system according to claim 1 where air with operating pressure is supplied to the brake valve of each wheel brake chamber directly and individually without using main brake valve or other brake relay valves, and for coupling trailers and semitrailers it is provided an additional brake actuation valve similar or identical with the wheeled ones.

3. Decentralized air braking system according to claim 1, where the hydraulic or electrical system may have one or more loops.

4. Decentralized air brake system in which the regulation of air pressure in the wheel brake chamber and the reaction to the signals from the wheel ABS sensor are controlled and done individually and independently for each wheel brake.
